(19) United States
(12) Patent Application Publication
(10) Pub. No.: US 2010/0306855 A1
(43) Pub. Date: Dec. 2, 2010

(54) Content Processing Apparatus and Content Processing Method

(75) Inventors: Shinya Suenaga, Fujisawa (JP); Naoki Mori, Yokohama (JP); Akira Tanaka, Kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Consumer Electronics Co., Ltd., Tokyo (JP)

(21) Appl. No.: 12/771,020

(22) Filed: Apr. 30, 2010

(30) Foreign Application Priority Data
May 29, 2009 (JP) 2009-129804

(51) Int. Cl. G06F 21/00; G06F 15/16

(52) U.S. Cl. 726/26; 709/217

(57) ABSTRACT

Having received an addition notification of a piece of download content, a content processing apparatus registers the notified content as a piece of download-scheduled content. The apparatus recalculates the priority rank of the download execution by taking into consideration a change in the license information on each piece of content, including a piece of already-preregistered download-scheduled content and a piece of content whose download is underway at present. If the download-execution target content specified by the recalculated priority rank is different from the content whose download is underway at present, the apparatus changes the download-execution target to the content specified by the priority rank.

INCORPORATION BY REFERENCE

The present application claims priority from Japanese application JP2009-129804 filed on May 29, 2009, the content of which is hereby incorporated by reference into this application.

### BACKGROUND OF THE INVENTION

The present invention relates to a content processing apparatus and content processing method for downloading plural pieces of contents from an external server via a network.

In recent years, in everyday-life electrical appliances such as television and recorder as well, there has been an increase in the number of appliances which are equipped with the network-connecting function. Many of the appliances like this permit users to acquire plural pieces of image contents via the network, and to enjoy themselves with the contents acquired. In the case where the users acquire their favorite contents via the network, and utilize the contents at whatever time they like, the method that they utilize then is basically classified into two schemes.

One scheme is referred to as “streaming”. This is the scheme whereby a piece of content acquired from the network is reproduced as it is without being stored. This scheme is implementable as long as a minimum capacity of data-receiving buffer memory is installed in the appliance used. The streaming scheme allows the reproduction to be started immediately after the content is specified. Accordingly, the streaming scheme is characterized by its handy ease-of-use.

The other scheme is referred to as “download”. This is the scheme whereby the content acquired from the network is stored into a memory device, and is reproduced afterwards. Adding the download function requires the addition of a large-capacity memory device for storing the entire content, such as hard disc drive (HDD). The download scheme is characterized by its broad-width usage methods, such as copying the content into another medium.

In the streaming scheme, it is difficult to reproduce a piece of content whose bit rate is higher than the bandwidth of the network. In order to view the high bit-rate content such as BD (high-definition) image, even ADSL, which is estimated to have the comparatively broad bandwidth, fails to ensure the sufficient bandwidth. Accordingly, there occurs a case where the set-up of a higher-speed network such as FTTH becomes necessary. Also, even in the wireless communications such as WiFi whose introduction into home is underway, in many cases, it becomes difficult to ensure the high-speed bandwidth stably.

In contrast thereto, in the download scheme, a certain extent of time is needed and spent in order to store the content into the memory device. As a result, it is possible to acquire the content whose bit rate is higher than the bandwidth of the network. The relaxation of the available condition permits more users to enjoy themselves with the content. Also, unlike the streaming scheme, the download scheme is not influenced by the communications environment. This is because the content is stored into the inside of the memory device. Consequently, it is highly expected that the download scheme can be utilized in the wireless communications appliances such as mobile telephone.

In the download scheme, however, the execution of the download necessitates an exceedingly long time, depending on the capacity of the content. This drawback results in a danger that the convenience of the user will be lowered. Accordingly, attempts have been made to improve this drawback.

For example, it is assumed that the reproduction of a piece of content cannot be carried out until the download execution of the content has been completed. In this case, the user cannot view the content even if the user wishes to view the content right now. In order to address the inconveniences like this, the progressive reproduction technology has been utilized. The progressive reproduction technology is the technology for making it possible to start the reproduction even in the case of a piece of content whose download has been not completed. Namely, at the time of the progressive reproduction, the download execution of the content and the reproduction of the content are carried out simultaneously. Even during the download execution of the content, this simultaneous processing makes it possible to start the reproduction of the content that the user wishes to view. The certain extent of buffer time, however, becomes necessary until the entire content has been progressively reproduced without being cut off halfway after the start of the download. As described earlier, this necessity results from the relationship between the bandwidth of the network and the bit rate of the content. In JP-A-2008-278090, an enhancement in the convenience is tried to be implemented by making it possible to calculate this buffer time.

Also, in the download scheme, depending on the service operation, a piece of pack content is set as the target of the services such as sales and download. Here, the pack content refers to a piece of content which is formed by collecting and summarizing plural pieces of contents into one piece of content. In this way, it is made possible to easily utilize plural pieces of contents such as serial contents as is the case with an ordinary single-piece content. In the download of the pack content, however, the plural pieces of contents within the pack are usually downloaded continuously. As a result, an exceedingly long time is necessitated until the download completion of the pack content. On account of this drawback, when the user wishes to download and view some other single-piece content during the download of the pack content, the user has been required to standby for a long time. In view of this situation, in JP-A-2008-25220, when the pack content is downloaded, the priority rank of the download execution can be made earlier with respect to a single-piece content purchased afterwards.

Also, it has been known that, in a system for downloading and reproducing a piece of content, the license management such as viewing time-limit is generally performed.

### SUMMARY OF THE INVENTION

Here, assume a case where, like JP-A-2008-25220, the download of plural pieces of contents is executed, and where, like JP-A-2008-278090, the progressive reproduction is performed with respect to a piece of content whose download is underway at present while downloading the plural pieces of contents. In this overall situation, in some cases, the viewing time-limit to be licensed becomes earlier with the content's reproduction start time defined as the criterion.

In this case, with respect to the content whose viewing time-limit has become earlier, there occurs a necessity for viewing the content earlier. As a result, the emergency for its download execution becomes urgent. In JP-A-2008-25220, however, no consideration is given to the circumstances like this. The download priority rank of the content, whose emergency for the download execution has become urgent, is addressed as being equivalent to the priority rank of an ordinary piece of content. Namely, it turns out that a higher priority rank is assigned to the download execution of some other content, and that a lower priority rank is assigned to the download execution of the content whose viewing time-limit has become earlier. On account of this situation, the following problems occurs: Even if the download of the content to which the lower priority rank is assigned has been terminated, a sufficient viewing time is lost up to the viewing time-limit. Otherwise, the viewing time-limit expires, and thus it becomes impossible to perform the viewing.

In order to solve the above-described problems, a content processing apparatus of the present invention for executing the download of plural pieces of contents via a network includes a download-execution control unit for calculating priority rank concerning the download of the plural pieces of contents, and causing the download to be executed based on the priority rank calculated, and a license control unit for collecting and managing license information on the plural pieces of contents to be downloaded, and, if the license information is changed, the license control unit notifying the download-execution control unit of the license information changed, wherein, when the download-execution control unit is notified of the changed license information from the license control unit, the download-execution control unit recalculates the priority rank based on the changed license information, and, if a change is present in the recalculated priority rank, causes the execution order of the download to be changed.

Incidentally, when the license information to be changed is a viewing time-limit in the above-described apparatus, if the viewing time-limit of a piece of certain content becomes earlier than the viewing time-limit of a piece of another content, the download-execution control unit assigning a higher priority rank to the download of the certain content as compared with the download of another content.

Also, when the license information to be changed is a reproduction time-limit in the above-described apparatus, if the reproduction time-limit of a piece of certain content becomes earlier than the reproduction time-limit of a piece of another content, the download-execution control unit assigning a higher priority rank to the download of the certain content as compared with the download of another content.

Moreover, in the above-described apparatus, the download-execution control unit is allowed to recalculate the priority rank by taking into consideration plural pieces of arbitrary information in addition to the changed license information, the plural pieces of arbitrary information being information such as other license information, usage situation of the contents, and criterion of a user that utilizes the download.

Also, a content processing method of the present invention for executing download of plural pieces of contents via a network includes a step of causing one of the plural pieces of contents to be downloaded with the highest priority rank assigned thereto among the plural pieces of contents, if the viewing time-limit or reproduction time-limit of the one piece of content becomes the earliest of the viewing time-limits or reproduction time-limits of the plural pieces of contents.

According to the present invention, in plural pieces of contents to be downloaded, a piece of content, whose license information is changed, and whose emergency for the download becomes higher, is downloaded with a higher priority rank assigned thereto. This method makes it possible to execute the download in an optimum order. Concretely, the download is made earlier with respect to the content whose viewing time-limit becomes earlier. This method makes it possible to implement the viewing-capable state immediately, thereby allowing implementation of an enhancement in the convenience of the user.

Other objects, features and advantages of the invention will become apparent from the following description of the embodiments of the invention taken in conjunction with the accompanying drawings.

### BRIEF DESCRIPTION OF THE DRAWINGS

FIG. 1 is a function configuration diagram of the entire system according to a first embodiment;

FIG. 2 is a flowchart of download-scheduled content registration according to the first embodiment;

FIG. 3 is an example of DL-execution control list according to the first embodiment;

FIG. 4 is a license-information changing flowchart according to the first embodiment;

FIG. 5 is a license-information changing flowchart according to a second embodiment;

FIG. 6 is an example of user notification according to the second embodiment; and

FIG. 7 is an example of the DL-execution control list according to a third embodiment.

### DESCRIPTION OF THE INVENTION

### Embodiment 1

Hereinafter, the description will be given below concerning the system configuration, methods, and programs of the present invention. Referring to the drawings, the explanation will be given below regarding an embodiment in the case where the viewing time-limit is taken into consideration as operation of the optimum download (DL) control.

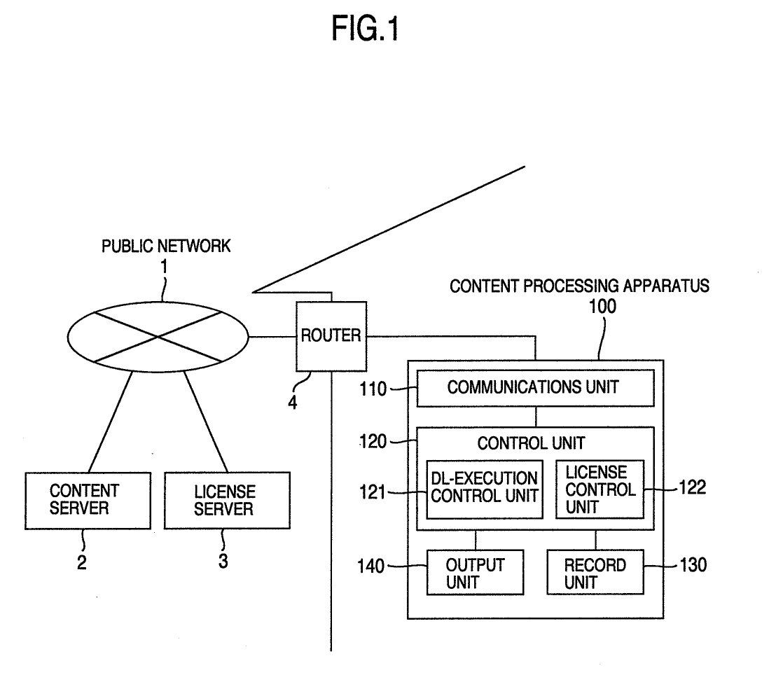

A function configuration diagram in FIG. 1 is capable of illustrating the main features of the present embodiment. In a content processing apparatus 100, when a DL-execution control unit 121 receives an addition notification of a piece of content which becomes the download target newly, the unit 121 registers the notified content as a piece of download-scheduled content. Moreover, the unit 121 calculates the priority rank of the download execution by taking into consideration license information on each piece of content, including a piece of already-preregistered download-scheduled content which becomes the download target. Furthermore, if the download-execution target content specified by the calculated priority rank is different from a piece of content whose download is underway at present, the unit 121 changes the download-execution target to the content specified by the priority rank.

Also, if usage conditions such as the viewing time-limit of a piece of content are changed by a change in the license information, the DL-execution control unit 121 acquires a notification about the license-information change from a license control unit 122. Moreover, the unit 121, in a manner where this license-information change is reflected, recalculates the priority rank of the download execution of the plural pieces of contents which become the download targets. Furthermore, the unit 121 causes the execution order of the download to be changed based on the recalculated priority rank.

In this way, in the case where there exist the plural pieces of contents, even if the usage conditions such as the viewing time-limit are changed, and even if the priority rank of the download for the user is changed, taking into consideration a change in the usage conditions such as license information allows the download to be carried out based on the optimum priority rank.

Referring to the function configuration diagram in FIG. 1, the explanation will be given below concerning the configuration of the present embodiment. The present embodiment includes a public network 1, a content server 2, a license server 3, a router 4, and the content processing apparatus 100. It is allowable, however, that the router 4 is omitted, and that the servers 2 and 3 co-exist inside one and the same appliance.

The content processing apparatus 100 in FIG. 1 includes a communications unit 110 for performing communications with the content server 2 and the license server 3 which are connected onto a public network 1, a control unit 120 for performing respective types of calculations and controls, a record unit 130 for recording the plural pieces of contents, and an output unit 140 for outputting the contents such as image, voice, and text data.

The content processing apparatus 100 is equipped with a download function. This download function allows a piece of content of the content server 2 to be received by the communications unit 110 via the public network 1 and the router 4, and to be recorded into the record unit 130 via the control unit 120. With respect to one or more pieces of contents, the executions of the downloads may be performed in a simultaneously-parallel manner. Moreover, a limitation resulting from capability of the apparatus may be imposed on the number of the simultaneously-parallel-capable downloads.

The content processing apparatus 100 is equipped with a license management function. This license management function allows the license information, which is needed for the usage or download of the contents, to be appropriately acquired and managed at the time of the content download start, at the time of the content output, or at points-in-time which are determined by respective types of services.

The record unit 130 is a large-capacity memory device such as hard disc, optical disc, or flash memory in terms of hardware. The unit 130 stores the information such as downloaded contents, control-use information, and license information.

As illustrated in FIG. 1, the control unit 120 of the content processing apparatus 100 includes the DL-execution control unit 121 and the license control unit 122. The DL-execution control unit 121 controls the download execution in the optimum sequence for the user with respect to the plural pieces of contents whose downloads are scheduled and whose downloads are underway at present. The license control unit 122 performs the acquisition, management, and control of the licenses needed for the acquisition and usage of the contents.

In more detail, when the DL-execution control unit 121 receives an addition notification of a piece of download content, the unit 121 registers this content as a piece of download-scheduled content. Moreover, the unit 121 acquires the license information from the license control unit 122 with respect to the plural pieces of contents which become the download targets. Subsequently, if a change is present in the license information such as the viewing time-limit in each piece of content, the unit 121 recalculates the priority rank of the download execution which is appropriate for the user. Then, the unit 121 controls the download execution in accordance with this recalculated priority rank.

Incidentally, the DL-execution control unit 121 may limit the number of the simultaneously-parallel-capable downloads, depending on performance of the components such as hardware and software. Also, the unit 121 may adjust the execution rates of the downloads in correspondence with the recalculated priority rank of each piece of content.

Also, the license control unit 122 acquires the licenses needed for the acquisition and usage of the contents, such as the download execution and reproduction of the contents. Furthermore, when the DL-execution control unit 121 and the output unit 140 execute the download and reproduction of the contents, the license control unit 122 manages the licenses appropriately. In addition, if the contents of the licenses are changed, the unit 122 notifies the DL-execution control unit 121 of the contents changed.

Incidentally, the license control unit 122 collects and manages the license information on the basis of notifications from the license server 3 and periodic accesses thereto.

Next, referring to the drawings, the explanation will be given below concerning an operation example of the system in the present embodiment.

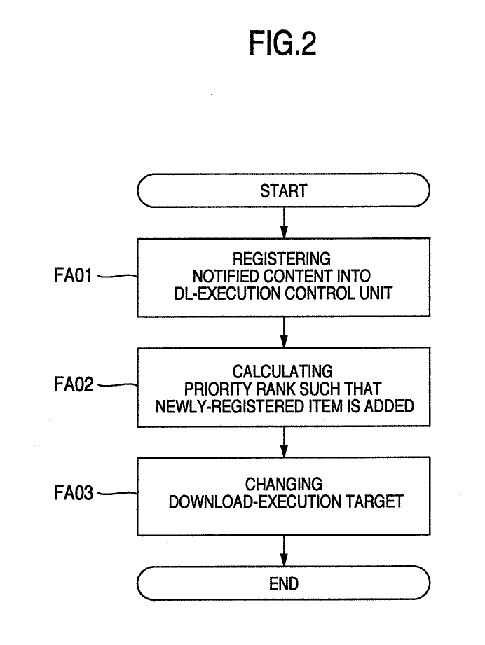

First, based on FIG. 2, the explanation will be given below regarding the case where the DL-execution control unit 121 receives the addition notification of a piece of download content, and registers this content as the download-scheduled content.

First of all, the DL-execution control unit 121 performs the registration processing as the download-scheduled content with respect to the content whose addition notification as the download content is performed (FA01).

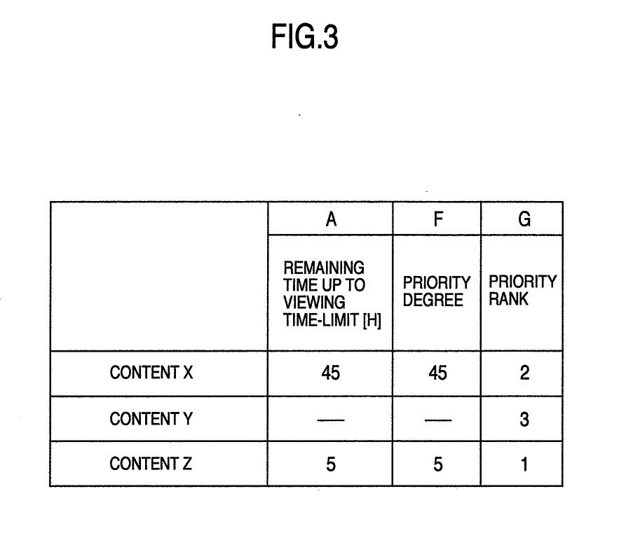

FIG. 3 illustrates, as a table-format list, information including the license information collected and managed by the DL-execution control unit 121. This list is utilized for the information management and the calculation of the priority rank in the DL-execution control unit 121. The format of the list, however, is not limited to the table format. Also, the priority rank to be calculated need not be determined by the method where the priority rank is determined using the numerical-value-based priority degree.

Furthermore, in the present embodiment, only the viewing time-limit is considered as the license information. The present embodiment, however, is not limited thereto, and thus the other license information may also be utilized.

Next, the DL-execution control unit 121 calculates the priority rank of the download execution with respect to the plural pieces of contents including the content newly registered at FA01, all of which become the download targets (FA02).

Here, in the calculation of the priority rank, in the list in FIG. 3 for example, the priority degree is defined as: (the priority degree)=(the remaining time up to the viewing time-limit). Namely, the smaller the priority degree of a piece of content is, the higher rank the priority rank of the content is set at. Also, the priority rank of a piece of content whose viewing time-limit has been not set is set at a lower rank.

Thanks to the definition of the priority degree like this, it turns out that the content whose remaining time up to the viewing time-limit is shorter can be downloaded with the higher priority rank assigned thereto. Accordingly, the user finds it possible to view the content earlier. Namely, taking the license information into consideration makes it possible to appropriately perform the download to which the higher priority rank should be assigned from the user's standpoint.

Subsequently, the DL-execution control unit 121 determines a piece of content which becomes the download-execution target newly in accordance with the priority rank changed by the calculation at FA02. Finally, the unit 121 halts the download which is underway at present, then starting the download of the content determined (FA03).

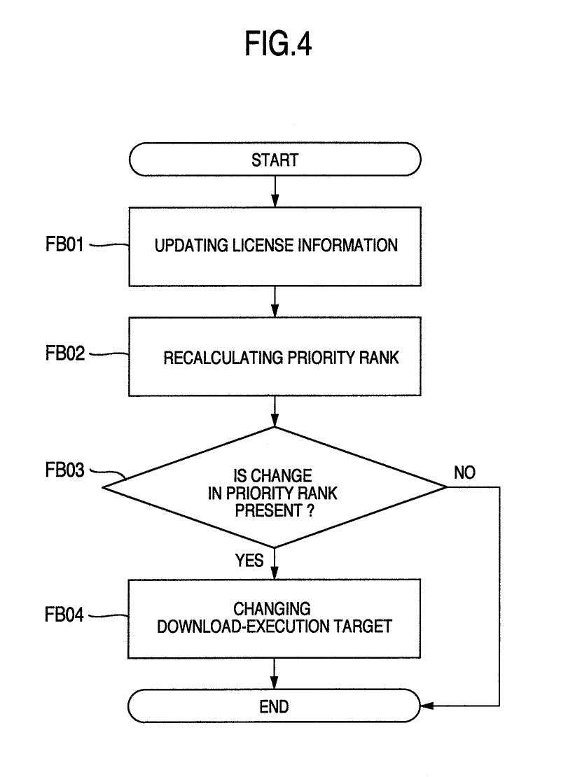

Next, based on FIG. 4, the explanation will be given below concerning the case where the license information such as the viewing time-limit of a piece of content is changed.

First of all, the DL-execution control unit 121 performs the information update, if a change in the license information is found out from the notification from the license control unit 122 or an access thereto (FB01). For example, if the viewing time-limit information is changed as the license information, it turns out that the remaining time up to the viewing time-limit in the A column is changed on the list in FIG. 3.

Next, the DL-execution control unit 121 newly recalculates the priority rank of the download execution, taking into consideration the changed license information as well (FB02). At this time, on the list in FIG. 3 for example, the priority degree in the F column is newly recalculated to recalculate the priority rank in the G column.

Subsequently, the DL-execution control unit 121 judges whether or not the priority rank is changed by the recalculation at FB02 (FB03). If a change in the priority rank is absent, the unit 121 terminates the processing. Meanwhile, if the change in the priority rank is present, a higher priority rank is assigned to the download of a piece of content whose download is not underway at present. Accordingly, the unit 121 judges whether or not the content should be employed as the download-execution target. Moreover, if the content should be employed as the download-execution target (FB04), the unit 121 halts the download of a piece of content whose download is underway at present, then starting the download of the content to which the higher priority rank should be assigned.

According to the above-described embodiment, even if the viewing time-limit becomes shorter with respect to a piece of content which becomes the download target, it becomes possible to address this situation by setting the priority rank of the download at a higher rank. Consequently, the user finds it possible to download the content with the higher priority rank assigned thereto, and to view the content earlier.

For example, consider a case where a shorter viewing time-limit and a longer reproduction-capable time-limit are set as the license for reproducing a piece of image content. In this case, even if the image content has been downloaded, and the longer reproduction-capable time-limit has been set, executing the progressive reproduction of the content once results in a possibility of the occurrence of a situation where the reproduction-capable time-limit is changed into the shorter viewing time-limit. At this time, if the execution sequence of the download is not changed without taking the license information into consideration, there exits a possibility of the occurrence of the following situation: Namely, with respect to the content whose time-limit is changed into the shorter viewing time-limit, the download is not completed despite the fact that the viewing time-limit has expired. According to the above-described embodiment, however, it becomes possible to avoid the situation like this.

### Embodiment 2

Next, the explanation will be given below concerning a second embodiment of the present invention.

In the above-described first embodiment, in the case where the license information such as the viewing time-limit is changed, the priority rank of the download execution is recalculated. Moreover, in accordance with the priority rank recalculated, the download-execution target is changed immediately. Sometimes, however, there may occurs a case where the user does not wish to apply the recalculated priority rank promptly. An example of this case is that the recalculated priority rank becomes unnecessary because the user has confirmed the content's contents using the progressive reproduction. Accordingly, in the present embodiment, after the recalculation of the priority rank, a notification for confirming whether or not to change the content which becomes the download target is issued to the user, using a notification unit such as pop-up or LED light-up. This notification is performed in order to confirm the consent of the user about the change.

The configuration of the present embodiment is basically the same as the one in the above-described first embodiment.

Next, referring to the drawings, the explanation will be given below regarding the operation of the system in the present embodiment.

The point in which the present embodiment differs from the first embodiment is as follows: The DL-execution control unit 121 acquires, from the license control unit 122, the notification about a change in the license information such as the viewing time-limit. Then, the unit 121 recalculates the priority rank of the download execution. The different point is that, after that, it is confirmed whether or not the user will give consent to a change in the priority rank.

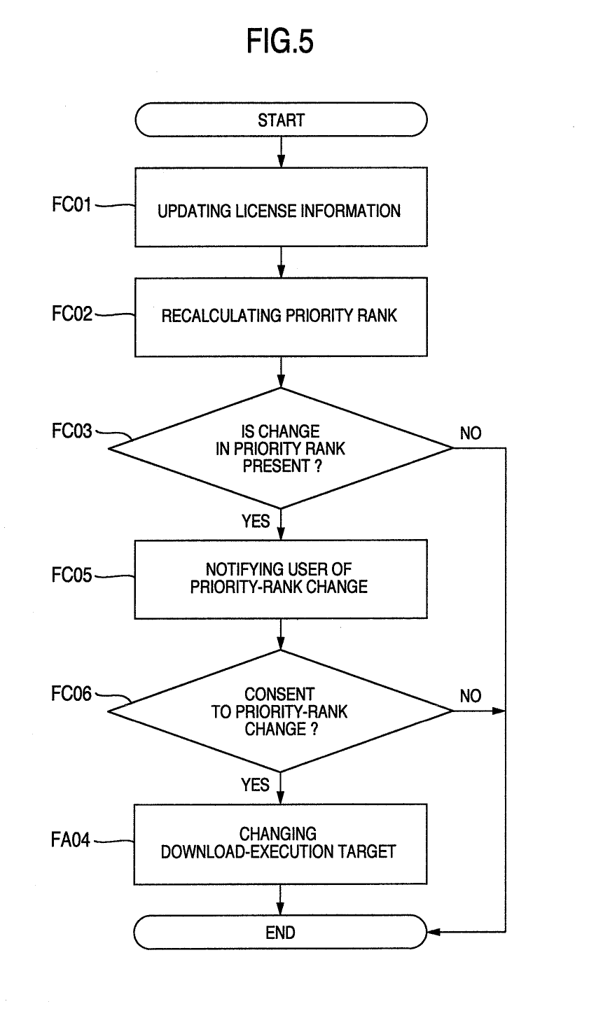

Based on FIG. 5, the explanation will be given below concerning a sequence for confirming the consent of the user.

Steps FC01 to FC03 are basically the same as the steps FB01 to FB03, respectively.

If, at the step FC03, the change in the priority rank is present, the DL-execution control unit 121 notifies the user that the priority rank is changed (FC05). After that, the unit 121 confirms whether or not the user will give the consent to the change in the priority rank (FC06). If the user does not give the consent, the unit 121 terminates the processing. Meanwhile, if the user gives the consent, at a step FC04, the unit 121 changes the download-execution target as is the case with the step FB04. What are conceivable as the methods for performing the notification at the step

FC05 and the consent confirmation at the step FC06 are as follows, for example: Selection operation based on the pop-up display via the output unit 140, predetermined operation corresponding to the LED light-up, and response to mail transmission via the communications unit 110.

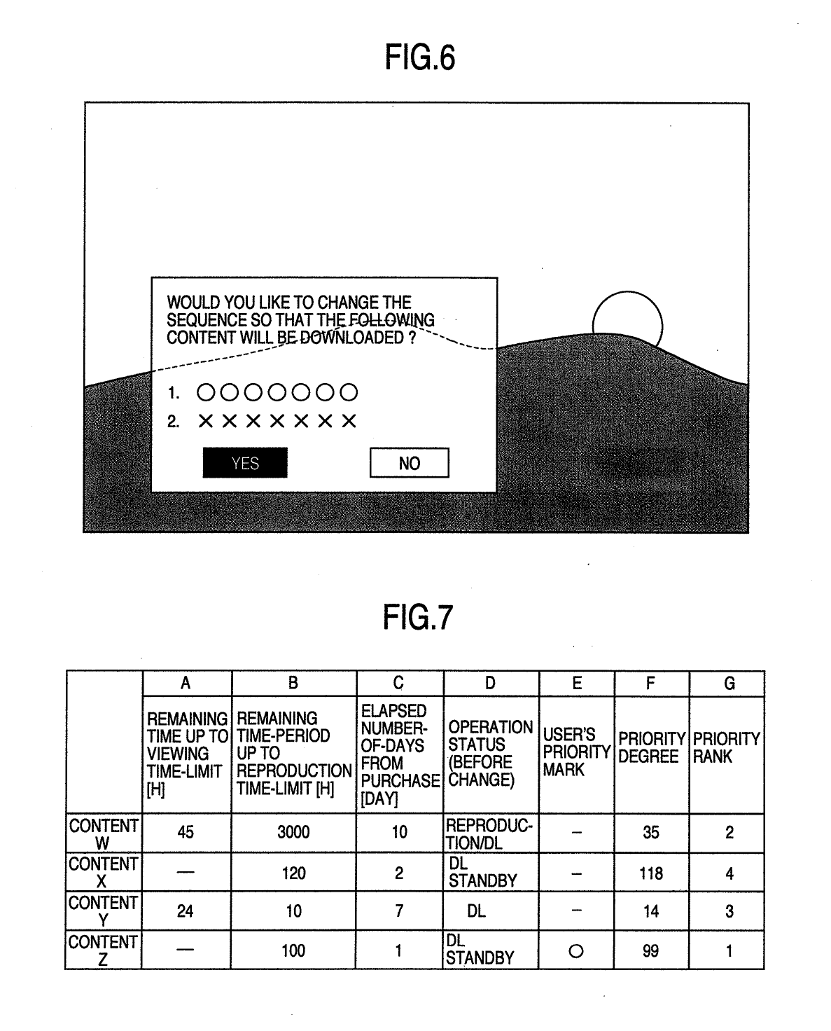

FIG. 6 is an example where, when carrying out the consent confirmation at the step FC06, the pop-up display onto the output unit 140 is used. By making the selection as to whether or not to give the consent from on the screen, the user can make the selection as to whether or not to change the download-execution target.

According to the present embodiment, by confirming whether or not the user will give consent to a change in the priority rank of the download execution, it becomes possible to execute the download with the priority rank necessary for the user.

### Embodiment 3

Next, the explanation will be given below regarding a third embodiment of the present invention.

In the above-described first embodiment, in the calculation of the priority rank in the DL-execution control unit 121, only the remaining time up to the viewing time-limit has been applied as the license information.

What are conceivable as the other applicable conditions for determining the priority rank are as follows: The other license information, usage situation of the content, and priority criterion unique to the user. Accordingly, in the present embodiment, the finer-grained and more-detailed priority rank is made calculatable by using these plural conditions. Incidentally, what are conceivable as the license information other than the viewing time-limit are as follows: The reproduction time-limit that defines a time-limit within which the reproduction of the content can be started, and an elapsed time that has elapsed from the purchase of the downloaded content.

The configuration of the present embodiment is basically the same as the one in the above-described first embodiment.

Next, referring to the drawings, the explanation will be given below concerning the operation of the system in the present embodiment.

The point in which the present embodiment differs from the first embodiment is as follows: The DL-execution control unit 121 calculates the priority rank by taking advantage of the plural pieces of information as well, such as the license information other than the viewing time-limit, the usage situation of the content, and the priority criterion unique to the user.

FIG. 7 illustrates, as a table-format list, an example of information collected and managed by the DL-execution control unit 121 in the present embodiment. Namely, the list in FIG. 7 is basically the same as the one in FIG. 3.

Here, the priority criterions for the respective plural pieces of information illustrated on the list are as follows:

As regards the remaining time A up to the viewing time-limit, the shorter the remaining time is, the higher priority the content must be viewed with. Accordingly, the download of the content must be completed with the higher priority assigned thereto.

As regards the remaining time-period B up to the reproduction time-limit, the shorter the remaining time-period is, the higher priority the content must be reproduced with. Consequently, the download of the content must be completed with the higher priority assigned thereto.

As regards the elapsed number-of-days C from the purchase of the content, the number-of-days during which the content has been not downloaded in spite of the purchase must be prevented from increasing. Accordingly, the download of the content whose elapsed number-of-days is larger must be completed with the higher priority assigned thereto.

As regards the operation status D, when the content is progressively reproduced during the DL, and when the viewing time-limit is set from its point-in-time, the download of the content must be completed with the higher priority assigned thereto.

As regards the user's priority mark E, when there exists a priority criterion unique to the user, such that there exists circumstances where the content must be viewed earlier than the other contents, the download of the content must be completed with the higher priority assigned thereto.

In the present embodiment, the priority criterions for the respective plural pieces of information as described above are taken into consideration. Then, a calculation expression of the priority rank where the plural pieces of information are taken advantage of is set to perform the calculation, depending on what extent of importance is placed on which piece of information.

An example of the setting is as follows: The values obtained by subtracting the numerical values in the C column from the smaller numerical values of the ones in the A column and B column, i.e., Min (A, B), are defined as the priority degrees. Then, the priority ranks are defined in the ascending sequence of the priority degrees. In the operation status D, however, with respect to the content W, whose progressive reproduction is underway, and the content Z, which is marked by the user so that its download should be executed with the higher priority assigned thereto, their priority ranks are set at higher priority ranks as compared with the download priority ranks set by the priority degrees.

According to the present embodiment, it becomes possible to set the finer-grained and more-detailed priority rank by calculating the priority rank of the download execution with the use of the above-described plurality of priority criterions. This feature allows implementation of an enhancement in the convenience of the user.

It should be further understood by those skilled in the art that although the foregoing description has been made on embodiments of the invention, the invention is not limited thereto and various changes and modifications may be made without departing from the spirit of the invention and the scope of the appended claims.

1. A content processing apparatus for executing download of plural pieces of contents via a network, said content processing apparatus, comprising:
a download-execution control unit for calculating priority rank concerning said download of said plural pieces of contents, and causing said download to be executed based on said priority rank calculated, and
a license control unit for collecting and managing license information on said plural pieces of contents to be downloaded, and, if said license information is changed, said license control unit notifying said download-execution control unit of said license information changed, wherein,
when said download-execution control unit is notified of said changed license information from said license control unit,
said download-execution control unit
recalculates said priority rank based on said changed license information, and, if a change is present in said recalculated priority rank,
causes said execution order of said download to be changed.

2. The content processing apparatus according to claim 1, wherein
said license information to be changed is a viewing time-limit,
if said viewing time-limit of a piece of certain content becomes earlier than said viewing time-limit of a piece of another content,
said download-execution control unit assigning a higher priority rank to said download of said certain content as compared with said download of another content.

3. The content processing apparatus according to claim 1, wherein
said license information to be changed is a reproduction time-limit,
if said reproduction time-limit of a piece of certain content becomes earlier than said reproduction time-limit of a piece of another content,
said download-execution control unit assigning a higher priority rank to said download of said certain content as compared with said download of another content.

4. The content processing apparatus according to claim 1, wherein
said download-execution control unit recalculates said priority rank by taking into consideration plural pieces of arbitrary information in addition to said changed license information, said plural pieces of arbitrary information being information such as other license information, usage situation of said contents, and criterion of a user that utilizes said download.

5. The content processing apparatus according to claim 1, further comprising:
a notification unit for presenting said presence of said change if said change is present in said recalculated priority rank in said download-execution control unit, and
a confirmation unit for performing a confirmation as to whether or not it is allowable to change said execution order of said download, wherein
said download-execution control unit causes said execution order of said download to be changed, if it has been confirmed that it is allowable to change said execution order.

6. The content processing apparatus according to claim 5, wherein
said notification unit is a pop-up display presented by an output unit for outputting said contents,
said confirmation unit being a selection based on said pop-up display.

7. A content processing method for executing download of plural pieces of contents via a network, said content processing method, comprising a step of:
causing one of said plural pieces of contents to be downloaded with the highest priority rank assigned thereto among said plural pieces of contents, if said viewing time-limit of said one piece of content becomes the earliest of said viewing time-limits of said plural pieces of contents.

8. A content processing method for executing download of plural pieces of contents via a network, said content processing method, comprising a step of:
causing one of said plural pieces of contents to be downloaded with the highest priority rank assigned thereto among said plural pieces of contents, if said reproduction time-limit of said one piece of content becomes the earliest of said reproduction time-limits of said plural pieces of contents.
